(19) United States
(12) Patent Application Publication
(10) Pub. No.: US 2026/0077505 A1
(43) Pub. Date: Mar. 19, 2026

(54) VISUAL ROBOTIC TASK CONFIGURATION SYSTEM

(71) Applicant: Tutor Intelligence, Inc., Cambridge, MA (US)

(72) Inventors: Joshua Aaron GRUENSTEIN, Cambridge, MA (US); Alon Zechariah KOSOWSKY-SACHS, Cambridge, MA (US); Zev MINSKY-PRIMUS, Cambridge, MA (US); Moises TREJO, Cambridge, MA (US); Tommy Seng HENG, Cambridge, MA (US); Joshua FISHMAN, Cambridge, MA (US); John STRANG, Cambridge, MA (US)

(73) Assignee: Tutor Intelligence, Inc., Cambridge, MA (US)

(21) Appl. No.: 19/109,411

(22) PCT Filed: Sep. 5, 2023
(86) PCT No.: PCT/US2023/073472

§ 371 Date: Mar. 6, 2025

Related U.S. Application Data
(60) Provisional application No. 63/404,400, filed on Sep. 7, 2022.

(51) Int. Cl. B25J 9/16; G06T 7/73

(52) U.S. Cl. CPC B25J 9/1697; B25J 9/1661; B25J 9/1666; G06T 7/73; G06T 2207/20092; G06T 2207/30241; G06T 2207/30261

(57) ABSTRACT

The present disclosure relates generally to robotic systems, and more specifically to systems and methods for specifying a robot task configuration by means of annotating a visual workspace representation in coordination with a waypoint optimization process. This system enables a much broader use of robotic automation by saving time and reducing technical complexity. This system can be used to configure any visually enabled robotic task, such as tasks in warehouse management, manufacturing, delivery, inspection, logistics, etc.

### CROSS-REFERENCE TO RELATED APPLICATION

This application claims priority to United States Provisional Ser. No. 63/404,400, filed on Sep. 7, 2022, the disclosures of which are incorporated herein by reference in their entirety.

### FIELD OF INVENTION

The present disclosure relates generally to robotic systems, and more specifically to systems and methods for specifying a robot task configuration by means of annotating a visual workspace representation in coordination with a waypoint optimization process.

### BACKGROUND

Traditional automation systems are configured by specifying sequences of sets of joint positions (“waypoints”) either by mathematical calculation or by manual positioning of a robot. Graphical human machine interfaces do exist and facilitate the creation of waypoints by means of simplifying the specification of specific waypoints without using code. Despite these advances, creating and optimizing a complex task composing a set of waypoints still requires painstaking work and lots of experience. The fundamental nature of waypoint creation by manually specifying specific robot positions remains the same unintuitive and tedious process as has existed for decades. Accordingly, there exists a need to provide a system for intuitively and/or automatically identifying waypoints associated with a robot task.

### BRIEF SUMMARY

Embodiments of the present disclosure include a configuration routine for a robot system to perform visual tasking, by a process of Visual Annotation, and Task Optimization. Embodiments in accordance with the present disclosure provide an intuitive system for a user to identify waypoints associated with a robot task. In one or more examples, embodiments of the present disclosure can provide an automated system to specify waypoints associated with a robot task. Unlike in the past, where robot tasks were configured by specifying various sets of robot positions (waypoints) or scene item or area locations manually, embodiments of the present disclosure provide systems simply that utilize one or more cameras to view the task area(s) to identify the waypoints to complete a robot task. Systems according to embodiments of the present disclosure may enable a broader use of robotic automation by saving time and reducing technical complexity. Embodiments of the present disclosure may include systems that can be used to configure any visually enabled robotic task, such as tasks in warehouse management, manufacturing, delivery, inspection, logistics, etc.

An exemplary method for specifying a robot task comprises: capturing, via one or more cameras, one or more images of a robot workspace, where the one or more cameras are mounted in an environment of the robot workspace; displaying a visual representation of the robot workspace to a user based on the one or more captured images; receiving, from the user, one or more annotations associated with the visual representation, wherein the one or more annotations include at least one of graphical annotations and natural language annotations; determining a set of waypoints based on the one or more annotations via an optimization process; and obtaining the robot task based on the set of waypoints and the one or more annotations.

In some embodiments, the visual representation comprises one or more live camera feeds of one or more cameras mounted on a robot.

In some embodiments, the visual representation comprises a 3D representation based on the captured images.

In some embodiments, the set of waypoints comprises a sequence of locations in the robot workspace that can be seen by the one or more cameras.

In some embodiments, the set of waypoints comprises a sequence of locations in the robot workspace that can be reached by a robot.

In some embodiments, the graphical annotations specify one or more regions of interest in the visual representation. The one or more regions of interest can be used to generate one or more waypoints at which the robot can reach the one or more regions of interest.

In some embodiments, the natural language annotations specify instructions associated with the robot task.

In some embodiments, the one or more annotations comprise an annotation associated with a prior robot task.

In some embodiments, the one or more annotations specify one or more landmark objects that can be used to localize a robot in the robot workspace.

In some embodiments, the one or more annotations specify one or more objects that can be manipulated by a robot.

In some embodiments, the optimization process comprises generating metadata associated with the robot task.

In some embodiments, the optimization process comprises validating the one or more annotations by algorithmically checking the one or more annotations against one or more preconditions. The one or more preconditions may comprise one or more of reachability of an annotated location, distance to a singularity, and travel distance.

In some embodiments, the optimization process comprises precomputing a set of trajectories between two or more waypoints of the set of waypoints to optimize one or more of speed, safety, obstacle avoidance, and travel distance.

In some embodiments, the robot task comprises one or more of performing pick and/or place operations, operating a machine, and loading and/or unloading a machine.

In some embodiments, the method further comprises providing visual feedback corresponding to an appearance of the robot workspace after the robot task is completed. The visual feedback may comprise a graphical display overlaid on the visual representation.

An exemplary system for specifying a robot task comprises: a robot; a robot workspace associated with one or more regions in an environment of the robot that the robot can reach; one or more cameras mounted in the environment of the robot; and an electronic device comprising one or more processors configured to perform a method comprising: capturing, via the one or more cameras, one or more images of the robot workspace; displaying a visual representation of the robot workspace to a user based on the one or more captured images; receiving, from the user, one or more annotations associated with the visual representation, wherein the one or more annotations include at least one of graphical annotations and natural language annotations; determining a set of waypoints based on the one or more annotations via an optimization process; and obtaining the robot task based on the set of waypoints and the one or more annotations.

An exemplary non-transitory computer-readable storage medium stores one or more programs, the one or more programs comprising instructions, which when executed by one or more processors of an electronic device of a system for specifying a robot task, cause the electronic device to: capture, via one or more cameras, one or more images of a robot workspace, where the one or more cameras are mounted in an environment of the robot workspace; display a visual representation of the robot workspace to a user based on the one or more captured images; receive, from the user, one or more annotations associated with the visual representation, wherein the one or more annotations include at least one of graphical annotations and natural language annotations; determine a set of waypoints based on the one or more annotations via an optimization process; and obtain the robot task based on the set of waypoints and the one or more annotations.

### DESCRIPTION OF FIGURES

FIG. 1A illustrates an exemplary robotic platform, in accordance with some embodiments.

FIG. 1B illustrates an exemplary annotation and optimization workflow, in accordance with some embodiments.

FIG. 2 illustrates an exemplary robot platform, in accordance with some embodiments.

FIG. 3 illustrates an exemplary robot hardware and camera work cell, in accordance with some embodiments.

FIG. 4 illustrates an exemplary annotation and optimization tool, in accordance with some embodiments.

FIG. 5A illustrates an exemplary visual region annotation and validation, in accordance with some embodiments.

FIG. 5B illustrates an exemplary view and waypoint optimization, in accordance with some embodiments.

FIG. 6 illustrates an exemplary workflow for creating a robot task, in accordance with some embodiments.

FIG. 7A illustrates an exemplary 2D visual representation, in accordance with some embodiments.

FIG. 7B illustrates an exemplary 3D visual representation, in accordance with some embodiments.

FIG. 8 illustrates an exemplary saved task page, wherein past jobs are visible and reusable, in accordance with some embodiments.

FIG. 9 illustrates an exemplary overlay of robot reachability, in accordance with some embodiments.

FIG. 10 illustrates an exemplary process for creating a robot task, in accordance with some embodiments.

FIG. 11 illustrates an exemplary electronic device, in accordance with some embodiments.

### DETAILED DESCRIPTION

Embodiments of the present disclosure include a configuration routine for a robot system to perform visual tasking, by a process of Visual Annotation, and Task Optimization.

Embodiments in accordance with the present disclosure provide an intuitive system for a user to identify waypoints associated with a robot task. In one or more examples, embodiments of the present disclosure can provide an automated system to specify waypoints associated with a robot task. Unlike in the past, where robot tasks were configured by specifying various sets of robot positions (waypoints) or scene item or area locations manually, embodiments of the present disclosure provide systems simply that utilize one or more cameras to view the task area(s) to identify the waypoints to complete a robot task. Systems according to embodiments of the present disclosure may enable a broader use of robotic automation by saving time and reducing technical complexity. Embodiments of the present disclosure may include systems that can be used to configure any visually enabled robotic task, such as tasks in warehouse management, manufacturing, delivery, inspection, logistics, etc.

The setup procedure can comprise two processes: Visual Annotation, and Task Optimization.

In Visual Annotation, an operator may be presented with a visual representation of the workspace of the robot, such as a point cloud or a video feed from a moveable camera. The operator uses a set of annotation tools to communicate various task-specific annotations which can be interpreted to configure task waypoints or to communicate task intent to machine learning models or human data labelers.

In Task Optimization, the set of annotations and the visual representation can be taken as input by an optimization procedure. The Task Optimization procedure will interpret the annotations, align the annotations into some model of the world, and optimize a set of waypoints that satisfy the requirements specified in Visual Annotation. The Task Optimization procedure can also generate metadata, which can assist in the robot task by specifying various characteristics of the task and/or the workspace.

An exemplary computer-enabled method for running a robot task configuration comprises: creating a visual representation of the workspace of the robot, by means of cameras that are on or about the robot; annotating the visual representation, by means of an annotation tool; validating the user annotations by means of an optimization procedure; optimizing a set of waypoints and task metadata, by means of an optimization procedure; adding the set of waypoints and task metadata to a robot platform in the form of a new task.

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

Although the following description uses terms “first,” “second,” etc. to describe various elements, these elements should not be limited by the terms. These terms are only used to distinguish one element from another. For example, a first graphical representation could be termed a second graphical representation, and, similarly, a second graphical representation could be termed a first graphical representation, without departing from the scope of the various described embodiments. The first graphical representation and the second graphical representation are both graphical representations, but they are not the same graphical representation.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]”or “in response to detecting [the stated condition or event],”depending on the context.

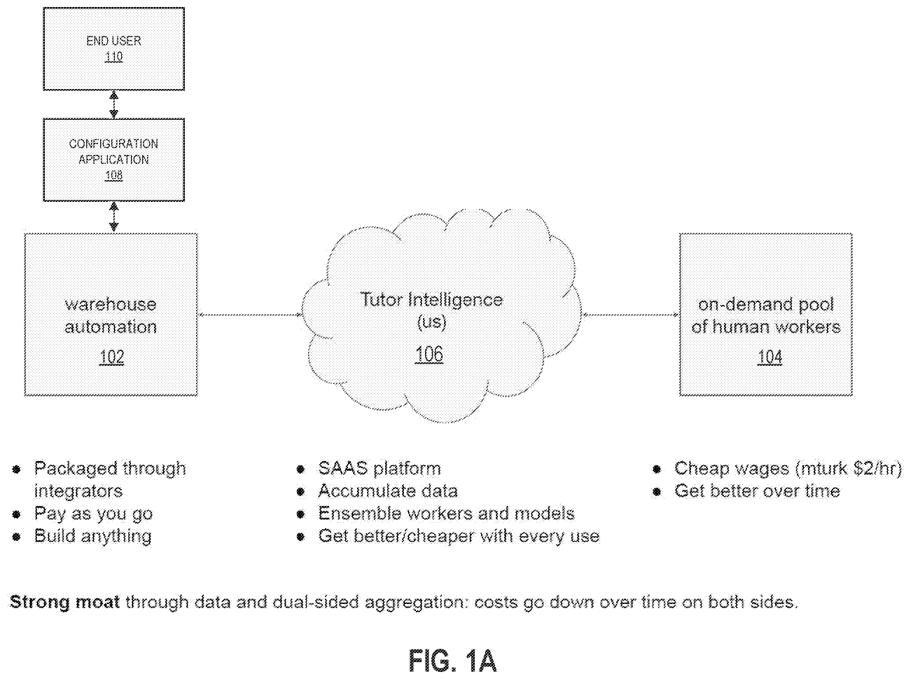

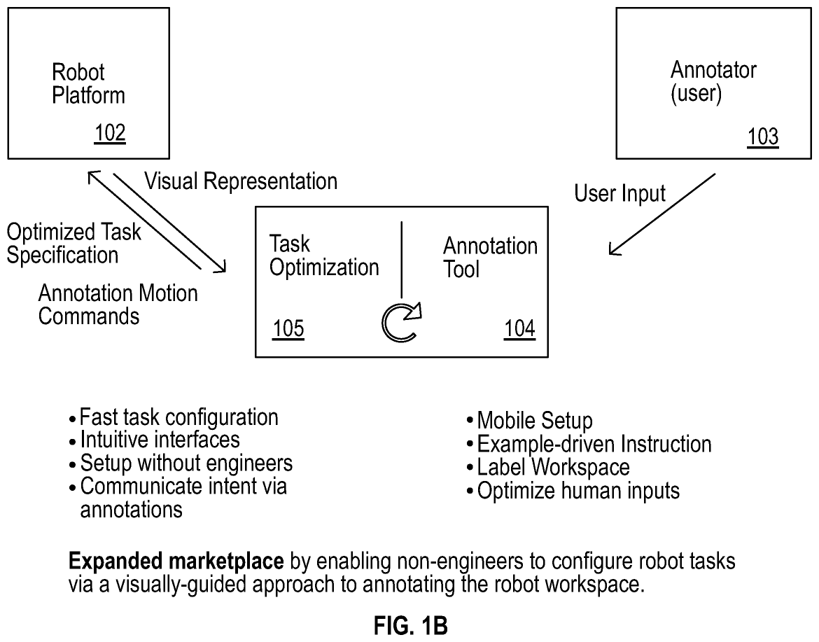

FIG. 1A illustrates an exemplary system, in accordance with some embodiments. The system comprise one or more robots 102, one or more human workers 104 responding to queries, and a cloud platform 106 communicatively coupled with the robots and the human workers.

Optionally, the system further comprises a configurations application 108 and one or more end users 110.

The robots 102 comprise sensing modules (e.g., camera, LiDAR sensor) and actuation modules (e.g., robotic arm). In some embodiments, the robotic arm comprises a camera at the end effector. In some embodiments, one or more components of the robots (e.g., camera) are connected to the Internet.

In some embodiments, the robots 102 are pick-and-place robots. Each robot can comprise one or more vacuum grippers with suction cups that grasp objects from a surface normal (e.g., Robotiq AirPick), parallel jaw grippers with two fingers that grasp from the side (e.g., Robotiq 2f-85), or any combination thereof. Different types of pick-point specifications are required for the two modes of grippers, and objects are often better suited for one type of gripper than another. In some embodiments, the robot may query the cloud platform 106 for which gripper to use (posed as a request form described below), and can switch grippers accordingly. It should be appreciated that any of robots 102 can be any type of robots that can be used to perform one or more tasks, such as pick-and-place robots having any type of gripping mechanisms.

In some embodiments, the robots 102 can be configured using configuration information before executing a task. As shown in FIG. 1A, the configuration information may be specified by the end user 110 (e.g., via a configuration application 108). Additionally or alternatively, the configuration information may also be specified by another user (e.g., human worker 104) or automatically by a different computer system (e.g., via an API).

The configuration information provides enough information during configuration such that the robot can operate independently. For example, the end user can specify broad directives/commands for the robot, such as a high-level task in natural language, a home position from which the workspace is visible, and additional high level task settings (e.g., whether the robot needs to be able to rotate objects). For example, a broad directive may be “sort the apples into the left bin and the bananas into the right bin” or “sort UPS packages into the left bin and FedEx packages into the right bin.”

In some embodiments, the robots 102 are registered and visible to the end user 110 through the configuration application 108. The configuration application 108 can be accessed using a user device (e.g., mobile device, desktop computer). The end user can view the status of all of their robots (e.g., running, stopped, offline, or emergency-stopped). In some embodiments, the end user 110 provides instructions (e.g., natural language instructions) via a user interface of the configuration application 108. For example, the user can provide the instruction via a textual input by typing a natural language text string into a user interface of the configuration application 108. As another example, the user can provide the instruction via speech input. As another example, the user can provide the instruction by selecting from preset options. It should be appreciated that any type of user interface may be provided by the configuration application 108 to allow input of configuration information such as natural-language instructions, for example, graphical user interfaces (e.g., of a web application) or programming interfaces.

In some embodiments, the configuration process comprises two steps. In a first step, a robot is positioned to an initial position (or home position). For example, the robot can be configured to point at its workspace (e.g., table with bins on it, a conveyer belt) such that all items to be manipulated are visible to the sensing modules. In the second step, instructions (e.g., natural language instructions) can be provided to the robot for what the robot should do (e.g., “sort the apples into the left bin and the bananas into the right bin,” “sort UPS packages into the left bin and FedEx packages into the right bin”). In some embodiments, the configuration can be done only while the robot is stopped.

In some embodiments, the configuration process is tailored based on a target application of the robots (e.g., assembly, packaging, bin picking, inspection) and thus the configuration application 108 may provide different user interfaces depending on the target application of the robots to facilitate input of the configuration information for the robots. For example, if the target application of the robots is to make kits of parts, the configuration application can provide a user interface allowing the user to select bins of parts and how many of each part should be picked to form a kit. This configuration would inform the high-level robot procedure, and the order and parametrization of high level operations such as picking, placing, and pushing. As another example, if the target application of the robots is to make kits of parts, the configuration application can be configured to receive and analyze a natural-language input to identify bins of parts and how many of each part should be picked to form a kit. In some embodiments, to determine the target application of the robots, the configuration application can receive an input indicating the target application of the robots to be configured and provide the corresponding user interface based on the target application. In some embodiments, to determine the target application of the robots, the configuration application can automatically analyze the robots to be configured, identify a target application of the robots, and provide the corresponding user interface to configure the robots accordingly.

Once the robot is configured, it can be started and begin to execute its main loop. At any time, the robot can be stopped from within the configuration application. For example, the end user can manually start and stop a robot via the configuration app. In some embodiments, the robot constantly queries the cloud platform 106 to determine its state (e.g., started or stopped), and behaves accordingly. In some embodiments, the robot receives command instructions and status updates from the cloud platform, rather than querying the configuration application for information and instructions. If the robot state changes from stopped to running, it queries the cloud service to find (or is automatically sent) its configuration data (e.g., the workspace pose and natural language instructions). If the robot stops unexpectedly (e.g. due to a safety issue, or the environment becoming misconfigured), the end user is notified through the app.

In some embodiments, the configuration process includes additional configuration steps performed by human workers 104, either to modify the end-user 110's configuration or to perform additional configuration steps. Combined, the configuration steps performed by the end user 110 and the human workers 104 can replace or augment traditionally highly-skilled programmatic systems integration work using lower-skill, on-demand labor.

The robots 102 can run software programs to execute the tasks to fulfill a command (e.g., specified by the configuration information provided by the end user). In some embodiments, the robots 102 comprises an embedded platform that runs the software programs. The programs can be structured as a loop to repeatedly execute a task. Exemplary tasks include picking and placing objects, verifying an image matches a set of defined conditions (e.g., that an e-commerce package contains all requisite items), etc. Each task can comprise multiple sub-tasks performed in a loop. Some sub-tasks of this loop may be locally executed (i.e., using parameters inferred by the robot), while other sub-tasks are outsourced to the cloud software by calling a proprietary API linked to the robot software. In some embodiments, rather than the robot running an independent loop and outsourcing sub-tasks for cloud execution, the primary activity loop is run on the cloud, and sub-tasks are outsourced to the robot for local execution.

The cloud platform 106 can receive a request from the robots 102. Additionally or alternatively, the cloud platform is configured to automatically provide information to the robot based on the status of the activity loop (e.g., outsourcing sub-tasks). Exemplary requests or information can include selecting where to pick an item and where to place an item in an image according to instructions, determining the fragility of an item in an image, etc.

In some embodiments, the request is in a predefined form. For example, the request provided by the robot includes: an image of the workspace, one or more natural task language instructions (received from the end-user through configuration), and queries for pick parameters and drop parameters. More complex request forms may include additional data from the robot (such as reachable poses, candidate picks, more end-user configuration settings) and query for more information from the service/human workers (which gripper to pick with, an angle to grip at, an angle to drop at, a height to drop from, etc.).

In some embodiments, each request form has an associated dataset of all requests made of that form and their responses by the human workers, and associated machine learning models supervised from that data, sometimes categorized by task or application. As an example, a request form can be for identifying a pick point in an image, and it can be associated with a dataset comprising all requests made (including the images) and all responses (including the points identified in those images). A machine-learning model can be trained using the dataset to receive an input image and identify a pick point in the input image.

After receiving a request, the cloud platform can query the corresponding machine-learning models to decide whether the models can produce a high-quality result, or if one or more human workers need to be queried. For example, an image is provided to the model and the model can output a predicted fragility of the item and output a confidence score. If the form model has high certainty or confidence for the request (e.g., above a predefined threshold), the cloud services uses the models to generate a response and returns it to the users. If the model is uncertain, the request can be added to a queue to be answered by remote human workers, and upon completion return it to the robot (and add the request to the associated dataset, which is then used to train models).

In some embodiments, additional algorithms can be used to double-check the results produced by either humans or models, e.g., by querying additional humans for consensus. Algorithms can also be used to provide higher compensation to workers who provide higher quality results.

In some embodiments, if more than one human workers are available to handle a request from the request queue, additional algorithms can be used to optimally match human workers and robot requests.

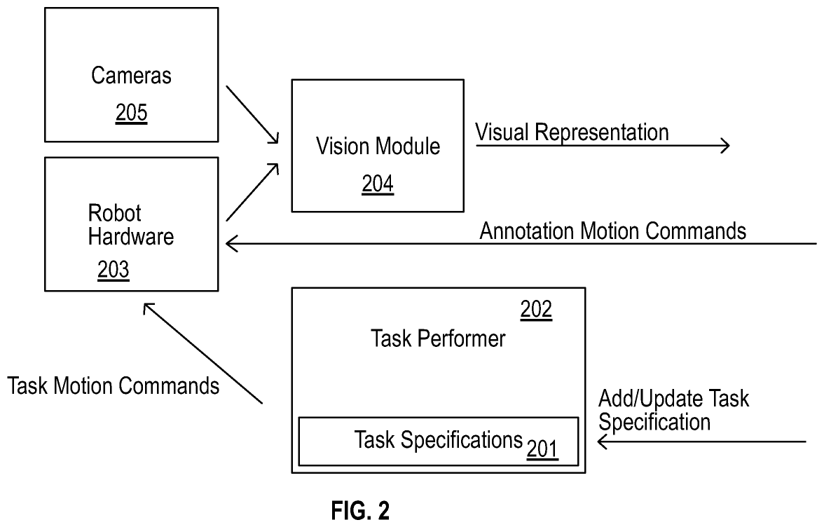

FIG. 2 illustrates an exemplary diagram of a robot platform in accordance with some embodiments. In one or more examples, the robot platform illustrated in FIG. 2 may correspond to the robot 102 described above with respect to FIG. 1A. The robot platform comprises robot hardware 203, cameras 205, a vision module 204 which produces visual representations for annotation, and a task performer 202 which directs the robot to follow task specifications 201. The task specifications 201 may be added from the optimization procedure described in greater detail below.

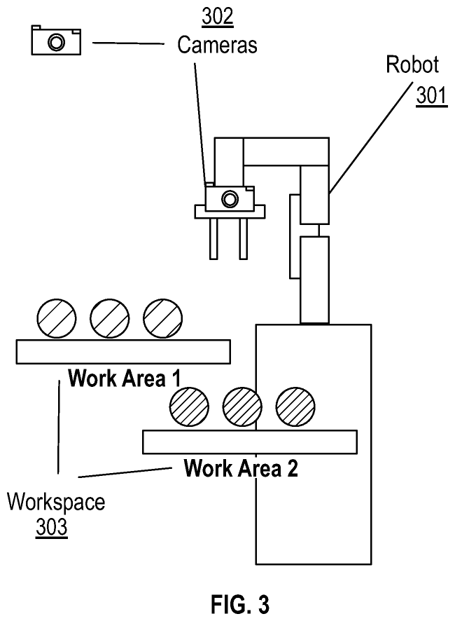

FIG. 3 illustrates exemplary robot and camera hardware in a workspace, in accordance with some embodiments. As shown in the figure, robot 301 (e.g., associated with robot platform 102) can be connected to one or more cameras 302. For example, the one or more cameras can be mounted to one or more portions of the robot 301, such as an armature or the body of the robot. In one or more examples, the one or more cameras can be mounted in the environment of the robot and provide a view of the robot 301. In one or more examples, the cameras can provide a view of a workspace 303. As used herein, the workspace may refer to the combined sum of the space that the robot can reach and that the cameras can see. As shown in FIG. 3, the workspace includes two work areas.

In some embodiments, the robot hardware (e.g., robot 301) can comprise a robot arm. In some embodiments, the robot hardware (e.g., robot 301) may include multiple robots operating in the same workspace or in adjacent workspaces. In some embodiments, the robot 301 may be on wheels, and may be transported between workspaces. In some embodiments, the robot 301 may be a robot arm mounted atop an autonomous ground vehicle.

In some embodiments, the camera hardware (e.g., cameras 302) can be mounted physically on the robot hardware. In such embodiments, moving the robot can adjust the camera's field of view. In some embodiments, measurements of the location of the camera with respect to one or more of the robot's joints can be used to localize the camera in the workspace. In some embodiments, a calibration procedure may be undertaken to perform and improve this localization.

In some embodiments, one or more of the cameras are stationary cameras that are detached from the robot. In some embodiments, the robot may perform motions or display various marked objects to the cameras to localize the stationary cameras in the workspace.

In some embodiments, one or more cameras are mobile. In such embodiments, the one or more cameras can be held by a human annotator. In some embodiments, this can include the camera located on a device held by the annotator, including on the annotation device itself. In some embodiments, a separate procedure can be used to localize the mobile camera with respect to the workspace. In some embodiments, this can take the form of photographing known landmark objects, using 2D or 3D points and/or features to align frames, or using annotations to record the locations of known objects, such as robot hardware.

FIG. 1B illustrates an exemplary process for a visual annotation process and task optimizing process to determine one or more waypoints, according to some examples. As shown in the figure, the system may include a robot platform 102, a task optimization procedure 115, and an annotation tool 114. In one or more examples, the task optimization procedure 115 and the annotation tool 114 may be performed on an electronic device, such as a computer. In one or more examples, the electronic device may be coupled to the robot platform 102. In one or more examples, the electronic device may be remotely located from the robot platform 102.

As shown in FIG. 1B, the system comprises a robotic platform 102 that presents a visual representation of the robot workspace to an annotator (the user) 113 by means of an annotation tool 114. The system utilizes the annotations via a task optimization procedure 115 to provide feedback and optimize a task which can be delivered to the robot platform.

In some embodiments, the task optimization procedure 115 may be used to specify a task where the robot platform 102 performs pick and/or place operations. The pick and/or place operations can be to and/or from a conveyor belt, worktable, containers, and other such standard workspaces. In some examples, the procedure can be used to rapidly create tasks for the same robot in multiple areas of an operation floor. In one or more examples, the system can perform the optimization procedure 115 multiple times on the same day, even within several minutes.

In some embodiments, the task optimization procedure 115 can be used to specify a task where the robot platform 102 operates a machine. For example, the robot platform 102 may place a workpiece into the machine or remove a workpiece from the machine after work has completed. Example machines include, but are not limited to, CNC Mills & Lathes, 3D printers, Laser Cutters, Waterjets, among others. In some embodiments the task optimization procedure 115 may also specify an inspection process, typically for quality assurance. In some embodiments, this will include the annotation of key measurements on a finished workpiece, the annotation of a reference workpiece that has been manually inspected, among other embodiments. These annotations can take the form of graphical annotations.

In some embodiments, the task optimization procedure 115 can be used to specify a task where the robot platform 102 builds and deconstructs organized arrays of objects. In some embodiments, the task optimization procedure 115 may specify a 2D grid structure over which to pick and/or place items. This 2D grid structure may correspond to tasks in various industries, such as picking and/or placing from 2D grids of vials and other containers.

In some embodiments, the arrays of objects constructed may be 3D. In some embodiments, this includes tasks in the manufacturing and logistics industries, such as building pallets and removing items from pallets. In some embodiments, these pallets can be all of the same items. In other embodiments, the pallets may contain mixed objects, such as boxes of different sizes and colors, bags, and plastic encased groups of items, such as water bottles. In some embodiments, the setup procedure may include a graphical annotation of one or more objects, which will aid the optimization step in creating a task to perform the creation or deconstruction of items in the pallet. In some embodiments, the task will include picking and/or placing from one pallet to another. In some embodiments, the task will include picking and placing between a pallet and an inbound or outbound workspace. In some embodiments, the optimization procedure will include creating 2D or 3D object plans, which may be visualized in the visual representation process to provide feedback to the annotator.

The annotator 113 may be an integrator, a factory worker, line operator, or remote operator. In some embodiments, the annotator may have little to no experience operating robots. To facilitate training and minimize required experience to annotate tasks correctly, the annotation tool may contain various levels, or modes, including an introductory mode which minimizes options and emphasizes core concepts. In some embodiments, the annotation tool may contain preset examples and image-based and/or video-based tutorials. In some embodiments, the annotation tool may contain an option to speak with or video conference with a remote instructor, who may assist with annotating a task. In some embodiments, the annotation tool may include instruction in many languages. In some embodiments, an experienced remote operator can refine the annotations to improve the downstream optimization.

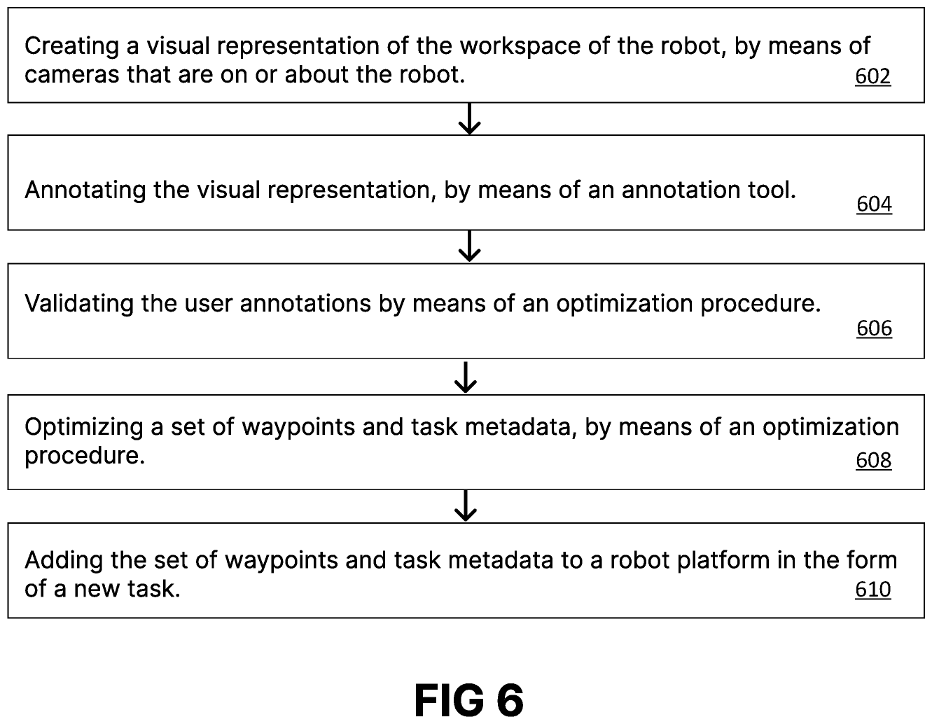

FIG. 6 illustrates a process for obtaining a robot task based on a Visual Annotation process and a Robot Task Optimization Process.

At block 602 of FIG. 6, the system can create a visual representation of the workspace of the robot by means of cameras that are on or about the robot. In one or more examples, a live feed of the visual representation can be presented to the user via a user interface associated with the robot platform.

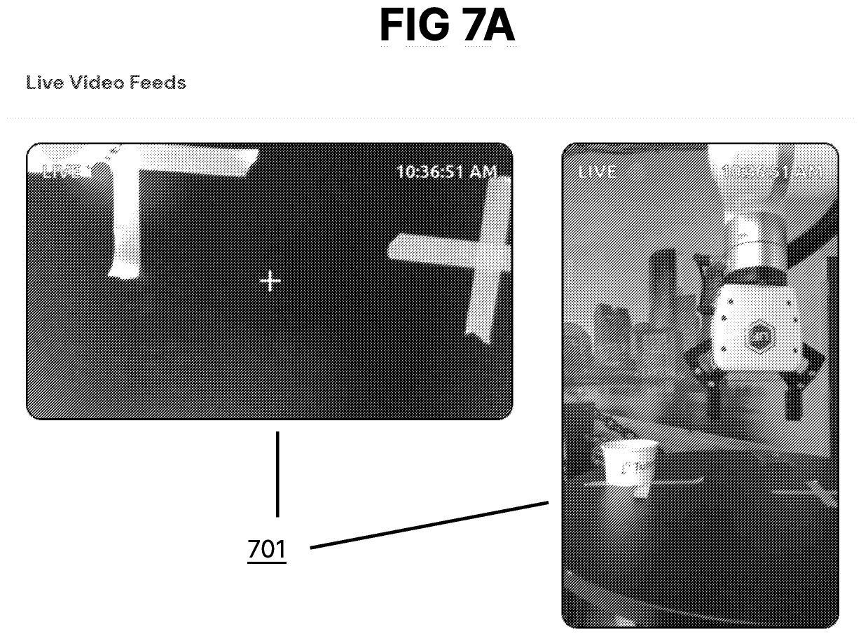

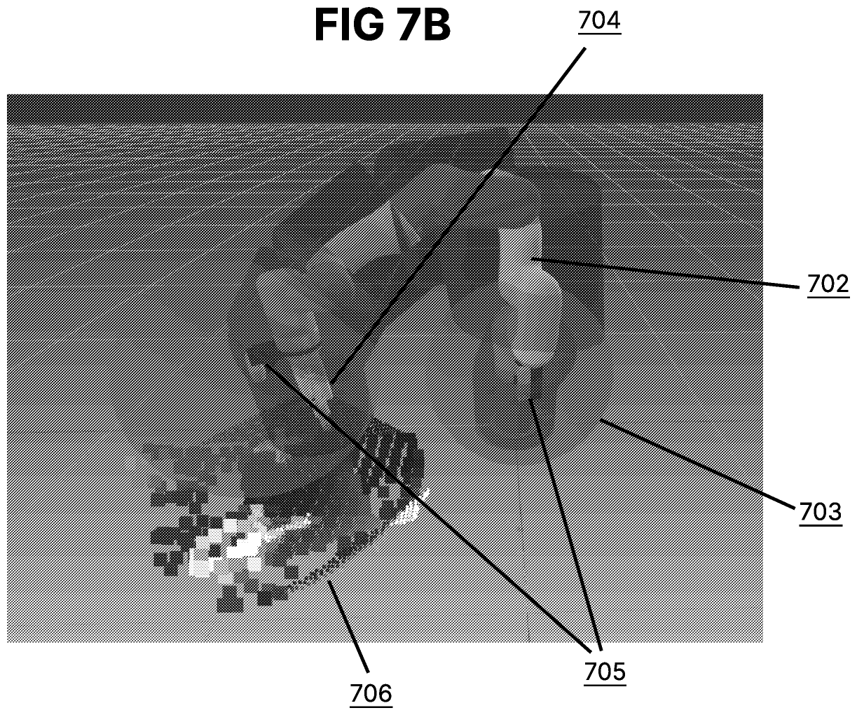

FIG. 7A illustrates an exemplary 2D visual representation, in accordance with some embodiments. The visual representation may be captured by cameras (e.g., cameras 302) mounted on or in the environment of the robot (e.g., robot 301). The visual representation compromises multiple live camera feeds 701 which indicate what the cameras in and around the workspace of the robot are currently seeing.

In some embodiments, the visual representation may contain static images. In some embodiments, these images are stitched together to give a broad view of the workspace. In some embodiments, this enables the visual representation to contain visual information that may be outside of the field-of-view of the cameras at a single moment in time.

FIG. 7B illustrates an exemplary 3D visual representation, in accordance with some embodiments. The visual representation compromises a 3D model of a robot 702, an end effector 704, and various cameras 705. A 3D representation of the workspace as sensed by said cameras 706 may also be displayed. Additionally, a graphic representation of various collision entities 703 is presented as part of the visual representation.

In some embodiments, the 3D visual representation may be labeled by the annotator by selecting specific points in the scene. In some embodiments, a single pixel may have stand-alone meaning, such as the location on an object to grasp at. In some embodiments, individual pixels may be labelled in association with a 2D plane or 3D shape. In some embodiments, the 2D plane or 3D shape may correspond to regions of space the robot may work in, or regions of space the robot may not trespass. In some embodiments, groups of pixels may be labelled on the surface of an object. In some embodiments, these pixels might have specific meaning, corresponding to such features as corners or visually identifiable landmarks on an object.

In some embodiments, the 3D representation of the workspace as sensed by the cameras may contain a point cloud. In some embodiments, the representation may be embodied as a mesh. In some embodiments, the 3D representation may be rendered by means of optimizing a differentiable rendering pipeline. In some embodiments, this pipeline may contain a neural network, such a neural radiance field network.

In some embodiments, the 3D representation of the workspace will contain elements that are not directly sensed by the cameras. In some embodiments, this will include a model of the robot, grippers, and/or cameras attached to the robot. In some embodiments, this may include predefined objects and/or obstacles in the workspace.

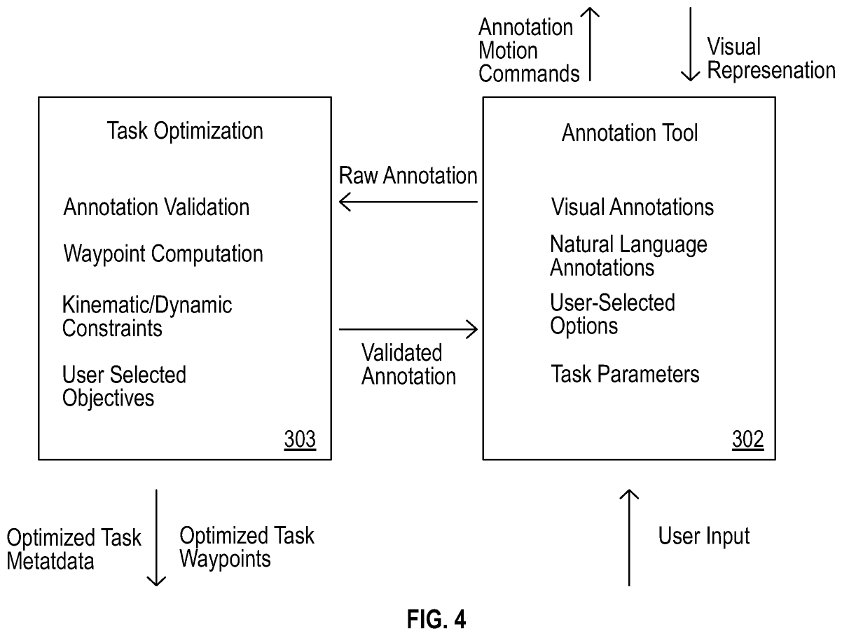

Referring back to FIG. 6, at block 604, the system can annotate the visual representation using an annotation tool. At block 606 of FIG. 6, the system can validate the user annotations using an optimization procedure. FIG. 4 illustrates an exemplary annotation tool and optimization procedure, in accordance with some embodiments. An annotation tool 302 displays a visual representation of the workspace of a robot platform to a user, who can annotate the visual representation with various annotations. Raw user annotations may be validated by an optimization procedure 303, and feedback provided to the user via the annotation tool. The aggregate annotations are optimized by the optimization procedure, to produce a set of waypoints and task metadata which can be transferred to the robot platform. During annotation and optimization, the robot may be instructed to move in the workspace to improve the visual representation among other reasons.

In some embodiments, the robot may be stationary during annotation. The robot may not need to be moved, if as an example, no cameras are mounted to the robot so adjusting the robot's position will not adjust any camera's field of view.

In some embodiments, the robot can be moved such that mounted cameras may view different locations of the workspace. In some embodiments, this motion occurs via a “neutral” or “free-drive” mode, allowing the annotator to push and pull the robot to various positions manually. In some embodiments, this motion occurs via teleoperation of individual joints. In some embodiments, the robot can be moved by specifying a relative motion in the camera feed, such as to move up, down, left, or right with respect to a given feed. In some embodiments, the robot can be moved via annotation of the visual representation. This may include specifying a region to inspect further inside the visual representation. In some embodiments, this may include drawing a target region to inspect. In some embodiments, the robot performs an autonomous scan of some or all of the workspace. In some embodiments, this scan may occur by moving to a set of known joint positions. In some embodiments, this scan may occur by moving joints that will maximally view different regions of the workspace, particularly regions that have little to no data associated with them. In some embodiments, this autonomous scan may be optimized to not trespass in regions of space that have not yet been visualized, in order to avoid the possibility of collisions with unseen objects.

In some embodiments, the workspace of the robot can be adjusted during annotation to provide examples of different objects or states the robot may encounter. In some embodiments, this may be performed by adding and removing objects from the workspace. In some embodiments, specific failure states may be annotated. In some embodiments, this may include input objects or collections of objects that are damaged. In some embodiments, this may include scenarios where no input object exists.

In some embodiments, the visual representation can be moved directly by the user, either by movement of some sensor (e.g., a camera or inertial measurement unit) or by external detection of the user's movement.

In some embodiments, the annotation can be performed via graphical annotations. In some embodiments, the annotation can be performed by drawing boxes or polygons in the visual representation. In some embodiments, this will specify various regions of interest. In some embodiments, the annotation can be performing by drawing a tool path for the robot to follow with its end effector. In some embodiments, the annotation can be performed by specifying individual pixels are clusters of pixels. In some embodiments, the annotation can be performed by specifying, for example, robot actions in the visual representation. In some embodiments this includes methods of grasping including gripper width, gripper force, and gripper offsets. In some embodiments, this specification occurs by selecting specific pixels that indicate gripper width, force, and offsets

In some embodiments, the annotation specifies one or more objects in the workspace. In some embodiments, the object can be one that the robot will be required to manipulate. In some embodiments, the annotation specifies one or more landmark objects that can be used to localize the robot in the workspace. In some embodiments, obstacles and regions of the workspace that may not be trespassed on by the robot may be annotated.

In some embodiments, the annotation can be performed by describing the task via natural language. In some embodiments, the annotation can be performed by inputting user text, recording audio instructions, recording video instructions, among other embodiments.

In some embodiments, the annotation can be seeded with one or more annotations from a prior task. These embodiments may exist to adjust to a robot position change and to save time by reusing setup results from a similar task.

In some embodiments, an algorithm may check the user annotations and provide feedback for the user to modify the annotation or the visual representation. In some embodiments, the algorithmic checking of the annotation suggests a preferred annotation or visual representation. In some embodiments, the visual embodiment can be automatically pre-annotated, sometimes to aid in the annotation process.

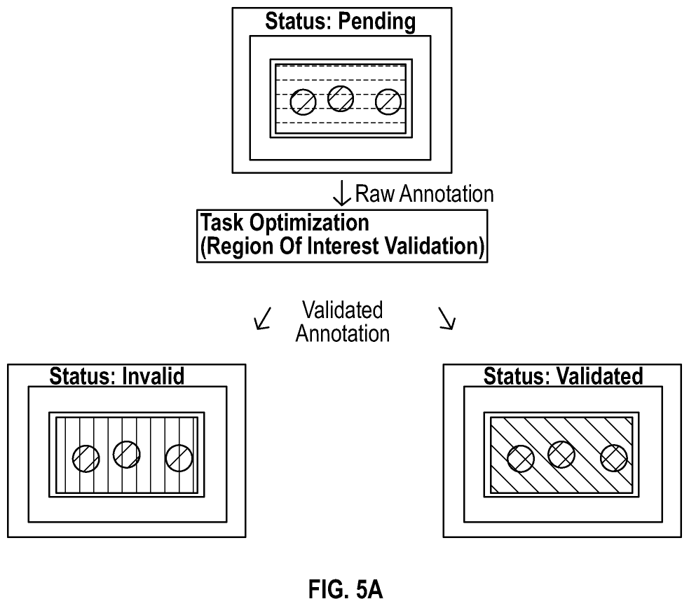

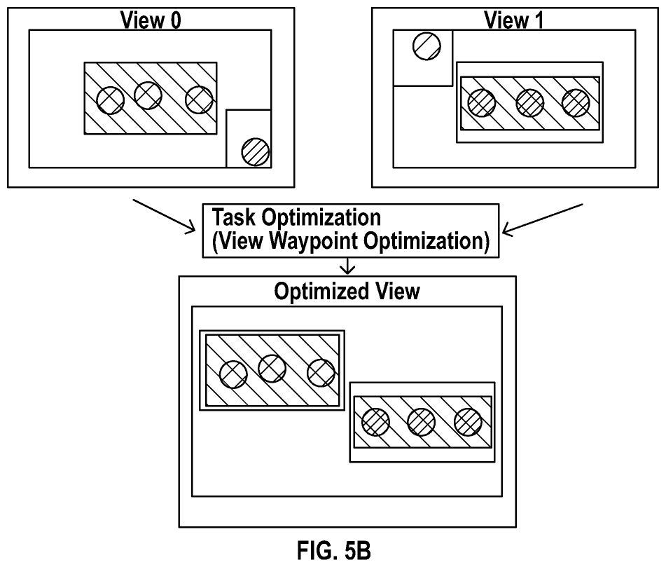

FIG. 5A illustrates an exemplary visual region annotation and validation, in accordance with some embodiments. As shown in the figure, once the visual region has been annotated, the annotation may be marked as pending. The system can then proceed to the task optimization process to validate a region of interest based on the annotation. The system may mark a pending visual annotation as invalid (e.g., as shown on the left) or validated (e.g., as shown on the right) based on one or more annotation procedures.

In some embodiments, the annotation can be algorithmically checked for validity against a set of pre-conditions. In some embodiments a precondition may include reachability of the annotated location. In some embodiments, a precondition may include distance to a singularity. In some embodiments, a precondition may include quality of the depth estimate. In some embodiments, a precondition may include distance that must be travelled in order to reach one or more points.

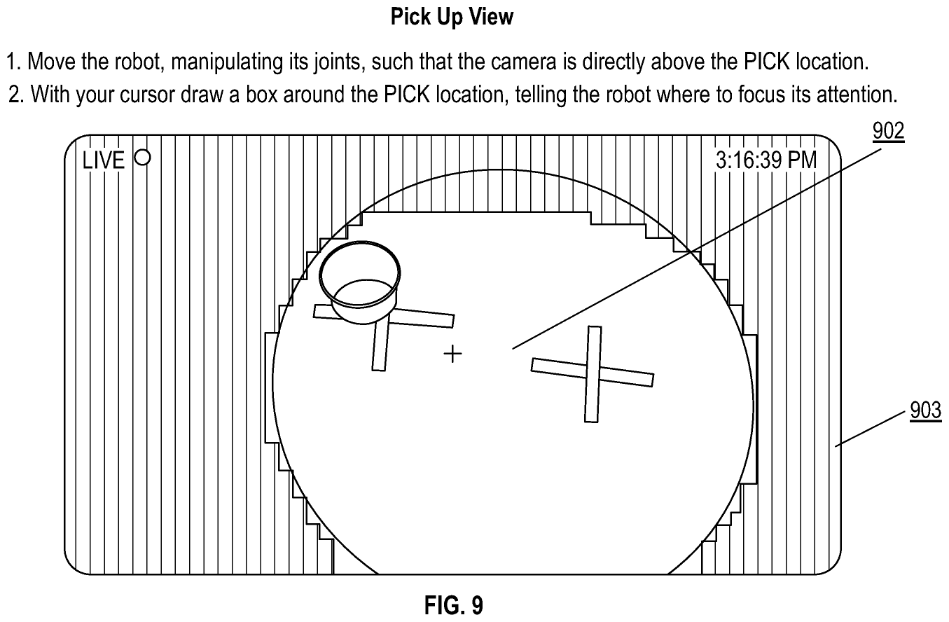

FIG. 9 illustrates an exemplary visual feedback system, wherein annotations are algorithmically checked against a condition, in this case reachability. As shown in FIG. 9, region 903 corresponds to areas that are out of reach by the robot, and region 902 corresponds to an area that is reachable by the robot. As shown in the figure, regions that pass the reachability check, e.g., region 902 may be visually distinct from regions that do not pass the reachability check, e.g., region 903. Accordingly, embodiments of the present disclosure provide the user with an intuitive means of understanding the effects of various condition checks. In the figure, visual feedback may be provided by indicating unreachable pixels as red. As another example in FIG. 5A, the visual feedback may be provided by coloring a region of interest with a color such as green.

In some embodiments, a visually distinctive mask may overlay the visual representation to indicate which items are reachable, e.g., as shown in FIG. 9. In some embodiments, the mask may serve only as an aide, but may be overridden. In some embodiments, an unmet condition may trigger a suggestion for a similar annotation that may be reachable. In some embodiments, an unmet condition may trigger an error and prevent further specification of the task.

In some embodiments, the optimization provides visual feedback corresponding to what the workspace will look like when the task is completed. In some embodiments, this feedback corresponds to a graphical display of objects that will be moved in the location they will be moved to. In some embodiments, this can take the form of a translucent, color-modified, patterned, or otherwise visually distinct overlay on the visual representation. The visual distinction may be used to communicate that the objects are not yet in their final locations but that the objects will be in the final locations when the task is performed. In some embodiments, particularly when multiple objects will be moved, this may also include an ordering and even a step-by-step transportation of objects such that the annotator may visualize what the task workflow will be, before the task is performed. In some embodiments, the visual feedback will also include a visualization of the robot performing the task as well. This feedback enables the operator to check for any potential problems, including collisions and objects being moved in the wrong order.

Referring back to FIG. 6, at block 608, the system can optimize the set of waypoints and task metadata using an optimization procedure. FIG. 5B illustrates an exemplary view and waypoint optimization, in accordance with some embodiments. For example, the system can determine an optimized view based on various views (e.g., view 0 and view 1) provided by one or more cameras (e.g., cameras 301). In some embodiments, the system can reduce the set of viewpoints needed to perform a task. For example, the user may select two regions of interest with the robot in distinct locations, and the optimization may find a single waypoint that satisfies both constraints. As shown in FIG. 5B, two distinct regions of interest can consolidated into a single waypoint.

In some embodiments, specific waypoints are annotated that may not be further optimized by the task optimization. Examples of waypoints that may not be further optimized may correspond to waypoints used to avoid obstacles. These obstacles may be challenging to incorporate into a visual representation (e.g., glass), or be located in regions of space where the cameras cannot see.

In some embodiments, annotated regions of interest are used to generate waypoints where the robot cameras can see the annotated regions. In some embodiments, annotated regions of interest are used to generate waypoints where the robot can easily reach the annotated regions.

In some embodiments, multiple annotated regions of interests, sometimes in different visual representations, are used to optimize joint objectives. In some embodiments, the method may adapt the number of optimized waypoints in accordance with certain objectives. For example, in some embodiments, it may be more efficient to select a waypoint that can see and/or reach two or more selected regions of interest. In some embodiments, the methods according to embodiments of this disclosure can identify waypoints from visual representations and annotation through the optimization of constraints such as gaze visibility or closeness to a target position.

In some embodiments, the optimization method may incorporate a robot model to incorporate certain dynamic properties of the robot as part of the objective function. In some embodiments these include friction, mass, moments of inertia, and force/torque limits of individual joints. In some embodiments, this includes user-provided safety and acceleration/speed limits. In some embodiments, robot waypoints are further optimized to improve kinematic feasibility. In some embodiments, this includes distance from a singularity and other regions of a robot's joint space that are adaptable to relative changes in task space. In some embodiments, robot waypoints are further optimized to increase speed and/or reduce the distance a robot must travel.

In some embodiments, the optimization process may incorporate approach trajectories and surface normal vectors, to determine the optimal path to reach various places in a region of interest. In some embodiments, many surface normal vectors from various locations may be consolidated to produce a more reliable result.

In some embodiments, the optimization process may search for waypoints that are far from robot joint configurations that impose various kinematic and dynamic issues. In some embodiments this may include distance from singular configurations. In some embodiments, an issue may be excessive motion of an individual joint. In some embodiments, this would impose a rate restriction, as moving all the joints a smaller amount is more efficient than moving a smaller number of joints a greater amount. In some embodiments, a large motion of a single joint can be an indication of a safety hazard.

In some embodiments the optimization process may utilize a set of predefined waypoints that serve as initial guesses for the optimization. In some embodiments this may serve to condition the optimization, such that the optimized waypoints are likely to have advantageous characteristics, such as range of motion. In some embodiments, this also may increase the speed of the optimization, by providing an initial guess that may be close to the correct answer. In some embodiments, simple heuristics, such as an initial guess that satisfies the greatest number of constraints, may be used to select the initial guess.

In some embodiments, this optimization can be performed via a linear or nonlinear optimization problem. In some embodiments, the optimization is performed via gradient descent. In some embodiments, this optimization is performed via a mixed-integer optimization. In some embodiments, this optimization is performed via a mixed-integer optimization.

In some embodiments, the method may precompute a set of trajectories between waypoints to optimize various objectives such as speed, safety, obstacle avoidance, and distance traveled. In some of these embodiments, the method may take into account various annotated objects in calculating collisions.

In some embodiments, 3D models of annotated objects may be created. In some embodiments, 3D models will be created in CAD, point cloud, 3D mesh, or other standard model formats. In some embodiments, 3D models will be created by optimizing a differentiable rendering and/or ray casting pipeline. In some embodiments, this may take the form of a neural network, such as a neural radiance field network.

In some embodiments, metadata may be exported in addition to waypoints. In some embodiments, the original annotations may be exported as metadata. In some embodiments, the annotations may be transformed by some function and may be exported as metadata. In some embodiments, this may be into another visual representation. In some embodiments, 3D models of annotated objects may be exported as metadata.

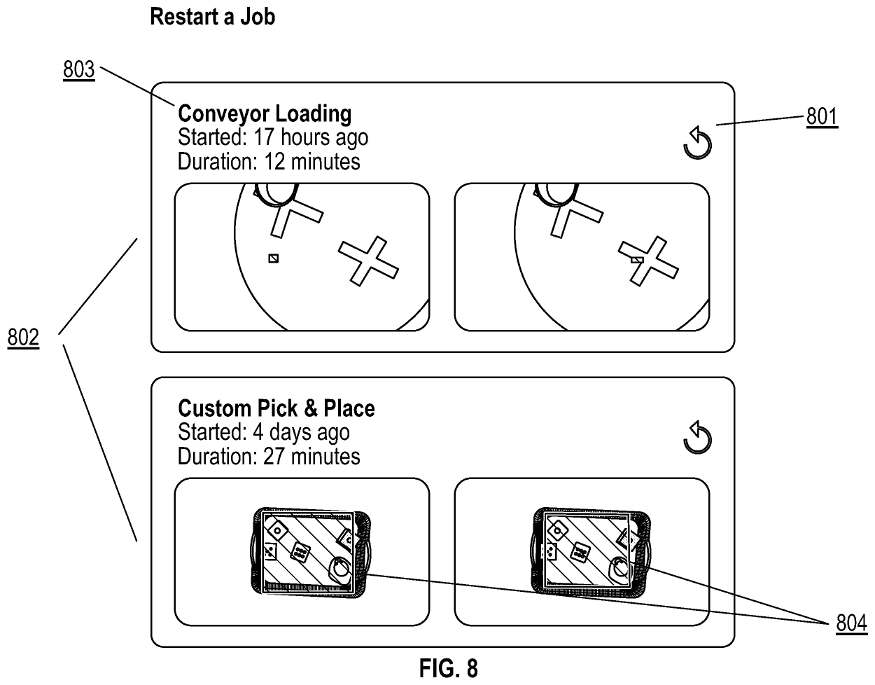

Referring back to FIG. 6, at block 610, the system can add the set of waypoints and task metadata to a robot platform in the form of a new task. FIG. 8 illustrates an exemplary representation of saved tasks with corresponding metadata. Multiple saved tasks 802 are displayed along with text-based metadata such as task name, task creation time, and task operation time 803 and graphical annotation metadata 803. A button 801 can be provided to enable rapid task adjustment by prepopulating the annotations back into the annotation tool.

In some embodiments, saved task metadata will be displayed to the annotator. In some embodiments, this includes basic text information such as task name, task creation time, and task duration. In some embodiments, this includes some or all of the visual representation of the task workspace. In some embodiments, this includes the annotations created via the annotation tool.

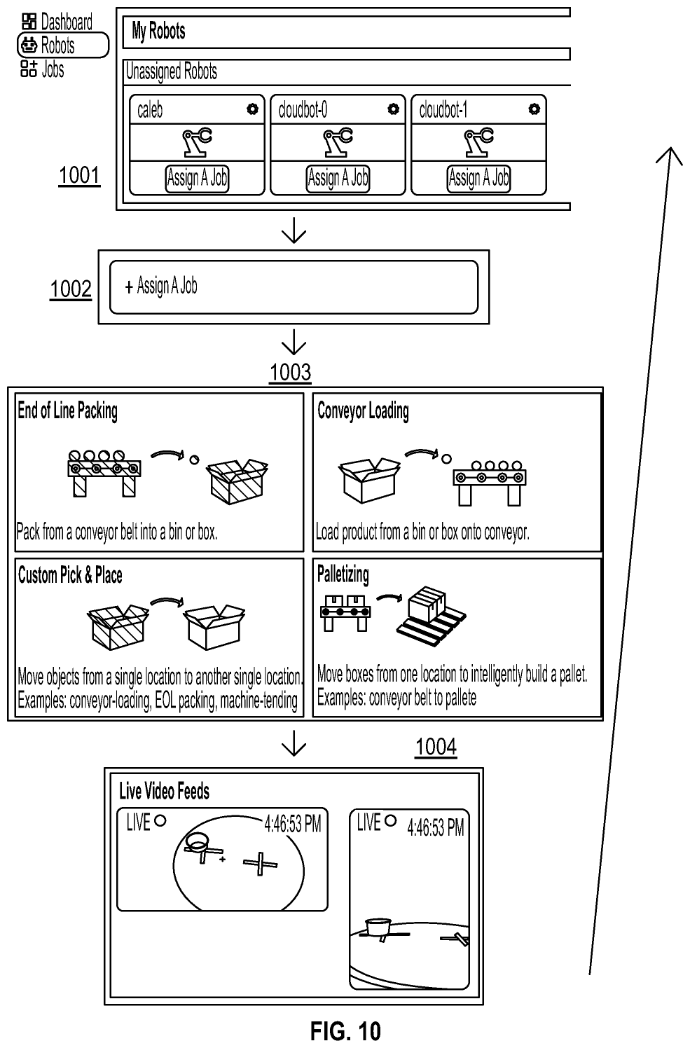

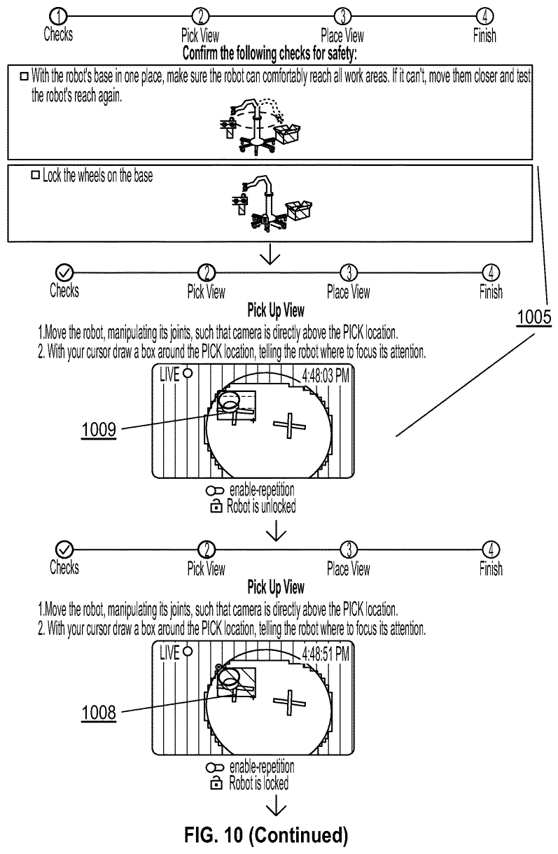

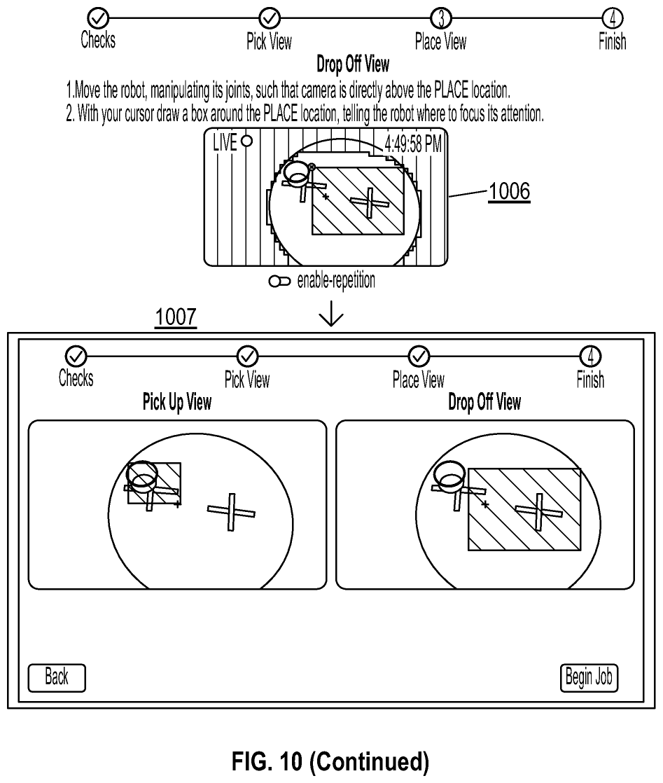

FIG. 10 illustrates an exemplary procedure, demonstrating an example of an embodiment of the method. In some embodiments the method can be based on a graphical interactive approach as follows:

At user interface 1001, the system presents a user with a user interface that allows a user to selects a robot to create a task for and assigns a task to. Prior to presenting this user interface the system may have received information regarding each of the robots to create a robot profile. In one or more examples, the robots may correspond to different types of robots. In one or more examples, the robots may correspond to the same type of robot. Once the robot is selected, the user interface can permit a user to assign a task to the selected robot.

At user interface 1003, the system can present the user with a user interface for selecting the type of task to perform 1003. The tasks may correspond to one or more pre-defined tasks, including, but not limited to, pick and place, end of line packing, conveyor loading, and palletizing. In some embodiments, the user may define a customized task, which may be more suited to the work environment and/or desired outcome than a predefined task. In some embodiments defining a unique task may include combining several lower-level skills or primitives together in a custom order. In some embodiments, the customized task may be created via a no-code or low-code interface. In some embodiments, this may be performed via a drag-and-drop style interface where the user orders a set of lower-level primitives. In some embodiments, the lower-level primitives may include visual picks and/or places.

At user interface 1004, the system can present a visual representation 1004 based on one or more cameras (e.g., cameras 301) associated with the robot. As shown in the figure, user interface 1004 includes two views corresponding to two cameras mounted on the robot. The first view may correspond to a camera mounted on an arm of the robot, that provides a view of a workspace. The second view may correspond to a camera mounted on the body of the robot or a camera mounted in the environment of the robot that provides a view of the workspace.

At user interface 1005, the system can provide instructions for the user to provide one or more safety checks. As shown in the figure, the first safety check may correspond to a user ensuring that the robot can comfortably reach all work areas. If the user determines that the robot cannot comfortably reach all work areas, the user should move the robot and test the reach of the robot again. The second safety check corresponds to a user ensuring that the wheels on the base of the robot are locked. In one or more examples, the specific safety checks may vary based on the specific robot selected at user interface 1001. For example, the second safety check may not be presented if the robot does not include wheels.

At user interface 1005, the system may present a user interface that allows the user to annotate a visual representation of the workspace. In one or more examples, the visual representation of the workspace will correspond to one or more of the views presented in user interface 1004. In one or more examples, the user may have an opportunity to annotate each of the views of the workspace. In one or more examples the user may annotate the most relevant view of the workspace.

The visual representation of the workspace as shown in user interface 1005 includes a visual indication of areas in the workspace that are reachable by the robot, e.g., as described above with respect to FIG. 9. In one or more examples, the visual indication of areas that are reachable by the robot may be used to guide the user's annotation of the workspace. As shown in user interface 1005, the user can annotate the visual representation of the workspace by drawing a box around a region of interest, e.g., the pick location. While a box is used in this example, any geometric shape may be used to identify the region of interest.

The user interface 1008 illustrates an example of an annotated pick-up location. User interface 1006 illustrates an example of an annotated drop-off location. In one or more examples, the user can further specify task parameters.

The system can give the user feedback by an optimization process, validating each annotation and offering suggestions.

Once the process is validated, the system can receive an selection from the user corresponding to the annotated task. The system can then perform an optimization process to generate a sequence of robot waypoints. Each waypoint may have specific visual meaning, e.g. One waypoint may be a location where the robot can see the pick area, and another waypoint may be a location where the robot can see the place area. The waypoints and additional metadata corresponding to the visual annotations may be saved to a task.

User interface 1007 may be presented to a user prior to a user running a specific task. The user interface may present visual representations of the workspace associated with the waypoints for the job. As shown in the figure, for a pick and place task, there may be a first visual representation of the workspace associated with the pick-up location and a second visual representation of the workspace associated with the drop-off location. As the system executes the task, the robot may follow the set of waypoints and may make a secondary motion at each. For example, at the pick waypoint, the robot may execute a pick before moving on to the next waypoint. In this way, the set of waypoints produced by the method may define a robot task.

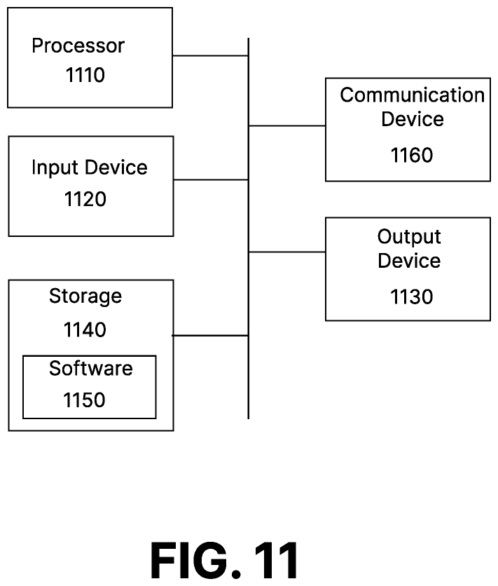

FIG. 11 illustrates an example of a computing device in accordance with one embodiment. Device 1100 can be a host computer connected to a network. Device 1100 can be a client computer or a server. As shown in FIG. 11, device 1100 can be any suitable type of microprocessor-based device, such as a personal computer, workstation, server or handheld computing device (portable electronic device) such as a phone or tablet. The device can include, for example, one or more of processor 1110, input device 1120, output device 1130, storage 1140, and communication device 1160. Input device 1120 and output device 1130 can generally correspond to those described above and can either be connectable or integrated with the computer.

Input device 1120 can be any suitable device that provides input, such as a touch screen, keyboard or keypad, mouse, or voice-recognition device. Output device 1130 can be any suitable device that provides output, such as a touch screen, haptics device, or speaker.

Storage 1140 can be any suitable device that provides storage, such as an electrical, magnetic or optical memory including a RAM, cache, hard drive, or removable storage disk. Communication device 1160 can include any suitable device capable of transmitting and receiving signals over a network, such as a network interface chip or device. The components of the computer can be connected in any suitable manner, such as via a physical bus or wirelessly.

Software 1150, which can be stored in storage 1140 and executed by processor 1110, can include, for example, the programming that embodies the functionality of the present disclosure (e.g., as embodied in the devices as described above).

Software 1150 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1140, that can contain or store programming for use by or in connection with an instruction execution system, apparatus, or device.

Software 1150 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Device 1100 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 1100 can implement any operating system suitable for operating on the network. Software 1150 can be written in any suitable programming language, such as C, C++, Java or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

### EXEMPLARY EMBODIMENTS

### System

In some embodiments, the robot is a robotic arm.

In some embodiments, one or more cameras are attached to the robot.

In some embodiments, one or more cameras are stationary cameras that are detached from the robot.

In some embodiments, one or more cameras are mobile and held by a human operator.

In some embodiments, multiple robots operating in the same workspace or in adjacent workspaces will share one or more steps of the setup procedure.

### Visual Annotation—Motion

In some embodiments, the robot is stationary during annotation.

In some embodiments, the robot is moved such that mounted cameras may view different locations via a “neutral” or “free-drive” mode, allowing the user to push and pull the robot to various positions manually.

In some embodiments, the robot is moved such that mounted cameras may view different locations via teleoperation of individual joint positions.

In some embodiments, the robot is moved by specifying a relative motion in the camera feed, such as to move up, down, left, or right with respect to a given feed.

In some embodiments, the robot is moved via annotation of the visual representation.

This may include specifying a region to inspect further inside the visual representation.

In some embodiments, the robot performs an autonomous scan of some or all the robot's workspace.

In some embodiments, the workspace of the robot is adjusted during annotation to provide examples of different objects or states the robot may encounter.

In some embodiments, the visual representation is moved directly by the user, either by movement of some sensor (e.g., a camera or inertial measurement unit) or by external detection of the user's movement.

### Visual Annotation—Visual Representation

In some embodiments, the visual representation is one or more live camera feeds of cameras connected to the robot.

In some embodiments, the visual representation is a set of images stitched together taken by the cameras connected to the robots.

In some embodiments, the visual representation is a 3D representation optimized by using one or more camera images at one or more moments in time.

In some embodiments, the visual representation is rendered via a neural network optimized from various camera images.

In some embodiments, the visual representation is pre-determined 3D representation of the scene.

### Visual Annotation—Annotation

In some embodiments, the task is obvious from the selected visual representation, and no additional annotation by the operator is needed.

In some embodiments, the annotation is performed by specifying various regions of interest in the visual representation. In some embodiments, this is performed by drawing boxes or polygons in the visual representation.

In some embodiments, the annotation is performed by describing the task via natural language. In some embodiments this is performed by inputting user text, recording audio instructions, recording video instructions, among other embodiments.

In some embodiments, the annotation is performed by specifying example robot actions in the visual representation. In some embodiments this includes methods of grasping including gripper width, gripper force, and gripper offsets.

In some embodiments, the annotation includes timing information, including delays, buffers, and speed constraints.

In some embodiments, the annotation is performing by drawing a tool path for the robot to follow with its end effector.

In some embodiments, the annotation is seeded with one or more annotations from a prior task. These embodiments may exist to adjust to a robot position change and to save time by reusing setup results from a similar task.

In some embodiments, the annotation specifies various examples of events that might occur while the robot performs the task. In some embodiments, these include errors, decision points, states of auxiliary equipment, invalid states, and other relevant events.

In some embodiments, the annotation specifies one or more landmark objects that can be used to localize the robot in the workspace.

In some embodiments, the annotation specifies one or more objects that the robot will be required to manipulate.

In some embodiments, an experienced remote operator will refine the annotations to improve the downstream optimization.

In some embodiments, the data annotation will direct the robot to perform additional movements to improve the quality of the visual representation for a specified area.

In some embodiments, the annotation is algorithmically checked for validity against a set of pre-conditions, such as reachability to the annotated location by a robot arm.

In some embodiments, the algorithmic checking of the annotation provides feedback for the user to modify the annotation or the visual representation.

In some embodiments, the algorithmic checking of the annotation suggests a preferred annotation or visual representation.

In some embodiments, the visual embodiment is automatically pre-annotated, sometimes to aid in the annotation process.

In some embodiments, specific waypoints are annotated that may not be further optimized by the task optimization.

In some embodiments, obstacles and regions of the workspace that may not be trespassed by the robot may be annotated.

### Task Optimization

In some embodiments, annotated regions of interest are used to generate waypoints where the robot cameras can see the annotated regions.

In some embodiments, annotated regions of interest are used to generate waypoints where the robot can easily reach the annotated regions.

In some embodiments, the method by which to identify waypoints from visual representations and annotation is through the optimization of constraints such as gaze visibility or closeness to a target position.

In some embodiments, the method may adapt the number of optimized waypoints in accordance with certain objectives.

In some embodiments, the optimization method may incorporate a robot model to incorporate certain dynamic properties of the robot as part of the objective function.

In some embodiments, the method will precompute a set of trajectories between waypoints to optimize various objectives such as speed, safety, obstacle avoidance, and distance traveled. In some of these embodiments, the method will take into account various annotated objects in calculating collisions.

In some embodiments, robot waypoints are further optimized to improve kinematic feasibility.

In some embodiments, robot waypoints are further optimized to increase speed and/or reduce the distance a robot must travel.

In some embodiments, multiple annotated regions of interests, sometimes in different visual representations, are used to optimize joint objectives.

In some embodiments, 3D models of annotated objects may be created.

### Task Metadata

In some embodiments, 3D models of annotated objects may be exported as metadata.

In some embodiments, the original annotations may be exported as metadata.

In some embodiments, the annotations may be transformed by some function and may be exported as metadata. In some embodiments, this may be into another visual representation.

### Task Examples

In some embodiments, the procedure is used to specify a task where the robot performs pick and/or place operations.

In some embodiments, the procedure is used to specify a task where the robot operates a machine.

In some embodiments, the procedure is used to specify a task where the robot loads and/or unloads a machine.

In some embodiments, the procedure is used to specify a desired pallet of various items.

In some embodiments, the procedure is used to specify a grid structure on which to perform actions over.

### System and Devices

In some embodiments, the procedure is used to specify a task where the robot performs pick and/or place operations.

1. A method for specifying a robot task, the method comprising:
capturing, via one or more cameras, one or more images of a robot workspace, where the one or more cameras are mounted in an environment of the robot workspace;
displaying a visual representation of the robot workspace to a user based on the one or more captured images;
receiving, from the user, one or more annotations associated with the visual representation, wherein the one or more annotations include at least one of graphical annotations and natural language annotations;
determining a set of waypoints based on the one or more annotations via an optimization process; and
obtaining the robot task based on the set of waypoints and the one or more annotations.

2. The method of claim 1, wherein the visual representation comprises one or more live camera feeds of one or more cameras mounted on a robot.

3. The method of claim 1, wherein the visual representation comprises a 3D representation based on the captured images.

4. The method of claim 1, wherein the set of waypoints comprises a sequence of locations in the robot workspace that can be seen by the one or more cameras.

5. The method of claim 1, wherein the set of waypoints comprises a sequence of locations in the robot workspace that can be reached by a robot.

6. The method of claim 1, wherein the graphical annotations specify one or more regions of interest in the visual representation.

7. The method of claim 6, wherein the one or more regions of interest are used to generate one or more waypoints at which the robot can reach the one or more regions of interest.

8. The method of claim 1, wherein the natural language annotations specify instructions associated with the robot task.

9. The method of claim 1, wherein the one or more annotations comprise an annotation associated with a prior robot task.

10. The method of claim 1, wherein the one or more annotations specify one or more landmark objects that can be used to localize a robot in the robot workspace.

11. The method of claim 1, wherein the one or more annotations specify one or more objects that can be manipulated by a robot.

12. The method of claim 1, wherein the optimization process comprises generating metadata associated with the robot task.

13. The method of claim 1, wherein the optimization process comprises validating the one or more annotations by algorithmically checking the one or more annotations against one or more preconditions.

14. The method of claim 13, wherein the one or more preconditions comprise one or more of reachability of an annotated location, distance to a singularity, and travel distance.

15. The method of claim 1, wherein the optimization process comprises precomputing a set of trajectories between two or more waypoints of the set of waypoints to optimize one or more of speed, safety, obstacle avoidance, and travel distance.

16. The method of claim 1, wherein the robot task comprises one or more of performing pick and/or place operations, operating a machine, and loading and/or unloading a machine.

17. The method of claim 1, further comprising providing visual feedback corresponding to an appearance of the robot workspace after the robot task is completed.

18. The method of claim 17, wherein the visual feedback comprises a graphical display overlaid on the visual representation.

19. A system for specifying a robot task, the system comprising:
a robot;
a robot workspace associated with one or more regions in an environment of the robot that the robot can reach;
one or more cameras mounted in the environment of the robot; and
an electronic device comprising one or more processors configured to perform a method comprising:
capturing, via the one or more cameras, one or more images of the robot workspace;
displaying a visual representation of the robot workspace to a user based on the one or more captured images;
receiving, from the user, one or more annotations associated with the visual representation, wherein the one or more annotations include at least one of graphical annotations and natural language annotations;
determining a set of waypoints based on the one or more annotations via an optimization process; and
obtaining the robot task based on the set of waypoints and the one or more annotations.

20. A non-transitory computer-readable storage medium storing one or more programs, the one or more programs comprising instructions, which when executed by one or more processors of an electronic device of a system for specifying a robot task, cause the electronic device to perform:
capturing, via one or more cameras, one or more images of a robot workspace, where the one or more cameras are mounted in an environment of the robot workspace;
displaying a visual representation of the robot workspace to a user based on the one or more captured images;
receiving, from the user, one or more annotations associated with the visual representation, wherein the one or more annotations include at least one of graphical annotations and natural language annotations;
determining a set of waypoints based on the one or more annotations via an optimization process; and
obtaining the robot task based on the set of waypoints and the one or more annotations.
